(19) United States
(12) Patent Application Publication
(10) Pub. No.: US 2005/0138297 A1
(43) Pub. Date: Jun. 23, 2005

(54) Register file cache

(75) Inventors: Avinash Sodani, Portland, OR (US); Per H. Hammarlund, Hillsboro, OR (US); Samie B. Samaan, Lake Oswego, OR (US); Kurt D. Kreitzer, Sherwood, OR (US); Tom D. Fletcher, Portland, OR (US)

Correspondence Address: KENYON & KENYON, 1500 K STREET, N.W., SUITE 700, WASHINGTON, DC, 20005, US

(73) Assignee: INTEL CORPORATION

(21) Appl. No.: 10/743,141

(22) Filed: Dec. 23, 2003

(51) Int. Cl. G06F 12/00

(52) U.S. Cl. 711/143

(57) ABSTRACT

Embodiments of the present invention relate to a system and method for associating a register file cache with a register file in a computer processor.

### BACKGROUND

Processor designers may seek improved performance by designing processors to be “wider” and more “deeply” speculative. A processor may be said to be “wider” than another when it has more execution units, and can therefore execute more instructions at the same time. For example, a processor with six execution units is wider than a processor with four execution units. Speculative processing in computers is a known technique that involves attempting to predict the future course of an executing program in order to speed its execution; a “deeply” speculative processor is one that attempts to predict comparatively far into the future.

Speculative processing requires storage to hold speculatively-generated results. The deeper a computer speculates, the more storage may be needed to hold the speculatively-generated results. The storage for speculative processing may be provided by a computer's physical registers, also referred to as the “register file.” Thus, one approach to better accommodating increasingly deep speculative processing could be to make the register file bigger. However, this approach would typically have associated penalties in terms of, among other things, increased access latency, power consumption and silicon area required.

Making a processor wider may also place increased demands on silicon area, and increase access latency and power consumption. This is due, among other reasons, to the increased “porting” of associated structures that is typically entailed in order to supply the additional execution units with instruction operands. “Porting” refers to how the physical structures used to hold data are read and written to. It is generally true that as the porting available to access a data storage structure increases, the more accesses to data in the structure may be simultaneously made. Thus, for example, when the data is instruction operands and results, increased porting may enable an increase in the number of instructions that can be executed at the same time.

In particular, instructions may read their source operands from registers in the register file, be executed by an execution unit, and write back their results to registers in the register file. For example, computer instructions known as “uops” (“micro-operations”) may each have two source (read) registers and one destination (write) register. Accessing corresponding registers in the register file for each uop may, accordingly, require two read ports and one write port: two read ports for the two source registers and a write port for the destination register. Thus, for example, a register file with ten read ports and five write ports could allow five uops to be executed per cycle; a register file with twenty read ports and ten write ports to could allow ten uops to be executed per cycle; and so on. However, a limiting factor on porting is that as structures become more heavily ported, they must typically become larger, consequently incurring a greater penalty in terms of area requirements, access latency and power consumption.

### BRIEF DESCRIPTION OF THE DRAWINGS

FIG. 1 shows a system according to embodiments of the present invention;

FIG. 2 shows a register file cache according to embodiments of the present invention;

FIG. 3 shows a process flow according to embodiments of the present invention;

FIGS. 4A and 4B show pipeline stages according to alternative embodiments of the present invention;

FIG. 5 shows further details of a register file cache to embodiments of the present invention; and

FIG. 6 is a block diagram of a computer system, which includes one or more processors and memory for use in accordance with an embodiment of the present invention.

### DETAILED DESCRIPTION

Embodiments of the present invention relate to a system and method for implementing a register file cache in a computer processor. The register file cache may enable a comparatively wider, more deeply speculative processor to be implemented while incurring a comparatively lesser penalty in terms of area, access latency and power consumption.

In conventional processors, source operands of an instruction are typically read from source registers in the register file and supplied to an execution unit to execute the instruction. A result of the executed instruction is then written back to a destination register in the register file. By contrast, according to embodiments of the present invention, a register file cache may be arranged between a register file and an execution unit of a computer processor. Data, for example, instruction operands, may be read from the register file cache rather than from the register file, and supplied to the execution unit to execute the corresponding instructions. Results of the executed instructions may be written back to the register file cache.

The register file cache may be configured to hold a predetermined amount of data, where the amount of data is smaller than the amount of data that the register file is able to accommodate. Data in the register file cache, however, may be more frequently accessed than is data in the register file. According to embodiments, a mechanism may be provided for moving data from the register file cache to the register file, based at least in part on how frequently the data is accessed.

Because the register file cache is configured to hold comparatively less data than is the register file, it may be smaller and therefore more heavily ported with a lower penalty in terms of area, latency and power consumption than would occur if equivalent porting were applied to the register file. Accordingly, the register file cache may enable a comparatively wider processor with a comparatively lower area/latency/power penalty. Further, because the register file may store data that is less frequently accessed than is data in the register file cache, it may be made with less porting than the register file cache, but still be relatively large. Therefore, the area/latency/power penalty associated with the register file may be made comparatively lower, while still providing the storage needed for deep speculative processing.

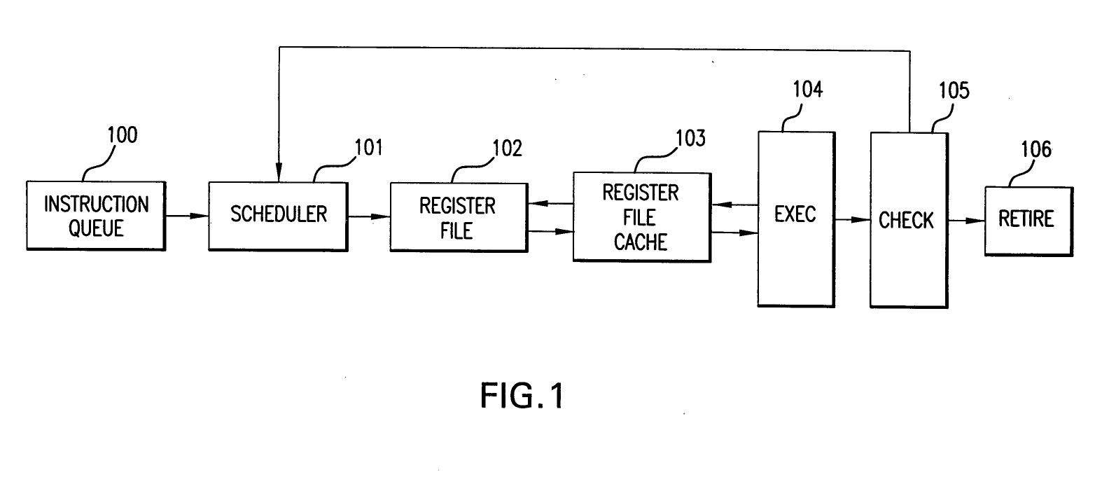

FIG. 1 illustrates elements of a system according to embodiments of the present invention. More specifically, FIG. 1 shows elements of a “back end” of a computer processor, where integrated circuit logic is shown as labeled rectangular blocks connected by directed lines. Some elements shown in FIG. 1 are conventional. That is, typically a back end of a computer processor includes an instruction queue 100, a scheduler 101, a register file 102, a plurality of execution units (“exec” block) 104, check logic 105, and retire logic 106. The instruction queue 100 may be coupled to the scheduler 101 and may hold instructions before they are inserted in the scheduler 101; the scheduler 101 may hold instructions until they are ready to execute, and then dispatch them for execution to the execution units 104. An instruction (e.g., a uop) may be considered ready for execution after its source operands have been produced.

The scheduler 101 may further be coupled to the register file 102. The scheduler 101 may schedule instructions for execution when their source operands have been written back to the register file 102 by the execution units 104. Conventionally, (i.e., in the absence of a register file cache arranged therebetween) the register file 102 may in turn be coupled directly to the execution units 104 for instruction execution and writing back of results of the instruction execution to the register file 102. The execution units 104 may be coupled to the check logic 105 for checking whether an instruction executed correctly or not. The check logic 105 may be coupled to the retire logic 106 for committing to the instruction's results if the instruction executed correctly, and to the scheduler 101 for re-executing the instruction if the instruction did not execute correctly.

According to embodiments of the invention, on the other hand, a register file cache 103 may be arranged between the register file 102 and the execution units 104, as shown in FIG. 1. The register file cache 103 may hold instruction operands supplied to the execution units 104 to execute instructions, and may further hold results written back following the execution of the instructions. More specifically, the register file cache may be a comparatively small structure that holds frequently-used register values, and that has a full set of read and write ports to service all of the execution units that may be present. Since the register file cache is comparatively small, it can be highly ported. By contrast, the main register file can be made comparatively large, to provide storage for speculative results, but minimally ported. Together, as noted earlier, these features may enable the implementation of a comparatively wider, more deeply speculative processor.

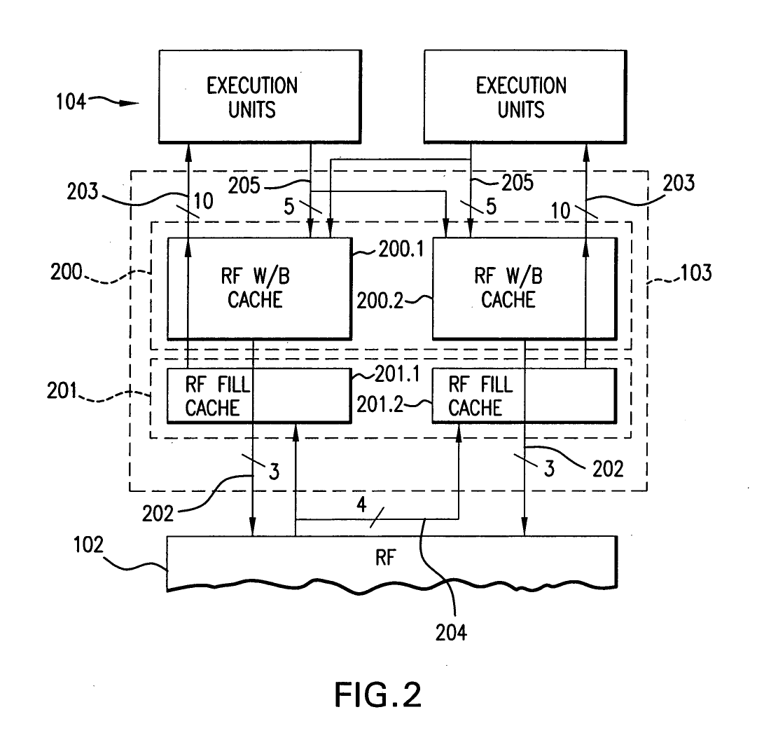

FIG. 2 shows an example of the register file cache 103 and associated structures in more detail. According to embodiments, the register file cache 103 may comprise two parts: a register file write-back cache (RF W/B cache) 200 and a register file fill cache (RF fill cache) 201. In the course of instruction execution, source operands of an instruction may first be looked for in the RF W/B cache 200 and the RF fill cache 201, as opposed to the main register file 102. If the source operands are found in either the RF W/B cache 200 or the RF fill cache 201 (a “hit”), they may be made available via read busses (where a bus comprises a plurality of connectors to corresponding ports) 203 from one of these caches to one of execution units 104 for execution of the instruction; a result may be written back via write busses 205 to the RF W/B cache 200. If the source operands are not found in either the RF W/B cache 200 or the RF fill cache 201 (a “miss”), they may be read from the main register file 102 via read busses 204 to execute the instruction; a result may be written to the RF W/B cache 200. More specifically, if there is a miss, the operands may be read via read busses 204 from the register file into the execution units, and at substantially the same time, copied into the RF fill cache 201. By placing “missed” operands in the RF fill cache 201, they may be more quickly and easily accessible in the event they are needed again in a short time, for example by a subsequent instruction. Periodically, data may be written from the RF W/B cache 200 to the register file 102 via write busses 202.

The RF W/B cache 200 and RF file cache 201 may each comprise two separate sections 200.1, 200.2 and 201.1, 201.2, respectively. The sections 200.1, 200.2 may be replicates of each other, and the sections 201.1, 201.2 may be replicates of each other; further, an “exclusive” write bus arrangement may be implemented as discussed in more detail further on. This arrangement may enable the register file cache to be implemented with comparatively less porting. In the example of FIG. 2, each RF W/B cache section 200.1, 200.2 has ten read busses 203 and five write busses 205 accessible by the execution units 104. For instructions (e.g., uops) having two source (read) registers and one destination (write) register, therefore, the structures shown in the example of FIG. 2 enable five execution units per cycle to be provided with instruction operands. However, the present invention is not limited with respect to the number of read and write busses and corresponding ports—more or fewer are possible.

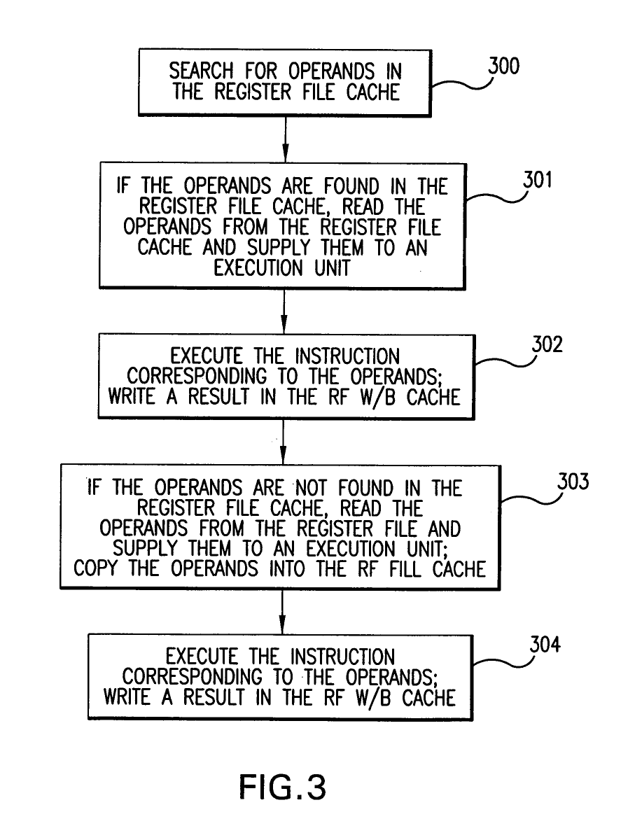

A process for executing instructions according to embodiments of the invention will now be described with reference to FIG. 3. As shown in block 300, control logic (not illustrated) may, pursuant to the execution of an instruction, cause the register file cache (both the RF W/B cache and RF fill cache portions) to initially be searched for the instruction's source operands. This may be done, for example, by a known “cam match” operation. The term “cam” is derived from “content addressable memory.”

If the instruction's source operands are found in the register file cache, they may be read from the register file cache and supplied to an execution unit to execute the instruction; block 301. A result of the execution of the instruction may be written back to a register in the RF W/B cache; block 302.

On the other hand, if the instruction's source operands are not found in the register file cache, they may be read from the register file instead and supplied to an execution unit, and at about the same time, copied from the register file into the RF fill cache; block 303. As can be seen in FIG. 2, the register file may be coupled via read busses 204 (four, in the example of FIG. 2) to the RF fill cache; these four busses may in turn be coupled to four of the ten read busses 203 of the register file cache coupled to the execution units. Thus; via these busses, data may read out of the register file directly into the execution units, and also into the RF fill cache. After execution of the instruction by an execution unit, a result may be written to the RF W/B cache; block 304.

It may be appreciated that the foregoing process and associated structures reduce the need for accesses to the larger register file and keep data that may be imminently required present in the smaller, highly-ported, more easily-accessed register file cache. However, because the smaller register file cache may become more quickly filled than the register file, embodiments of the invention further provide for moving data that may not be imminently needed from the register file cache to the register file. This moving of data from the register file cache to the register file may be referred to herein as a “periodic writeback”; the periodic writeback may provide the dual features of freeing up registers in the register file cache for the writing of new data, and of preserving data for a comparatively longer term in the less-frequently accessed register file.

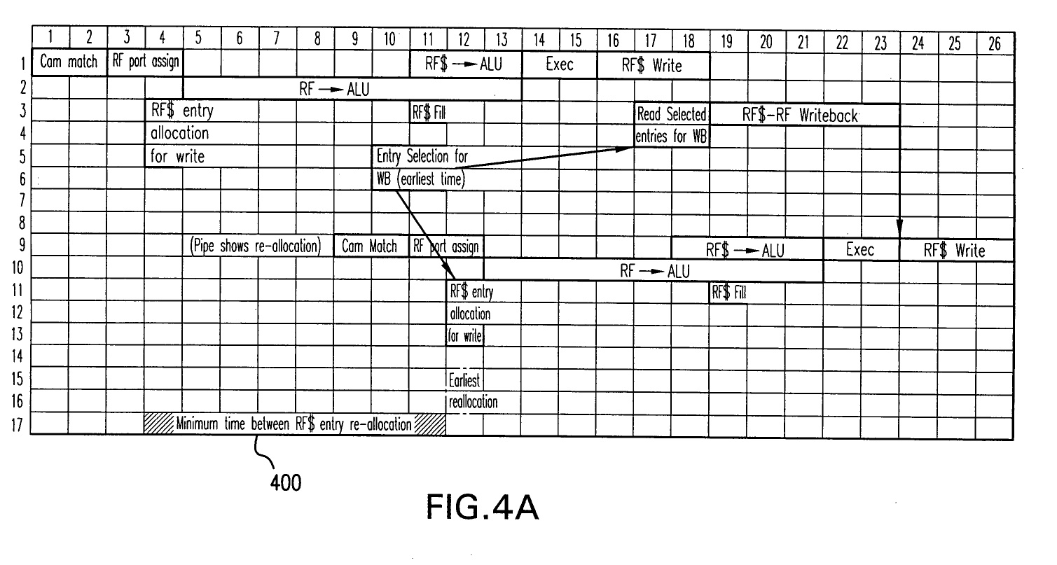

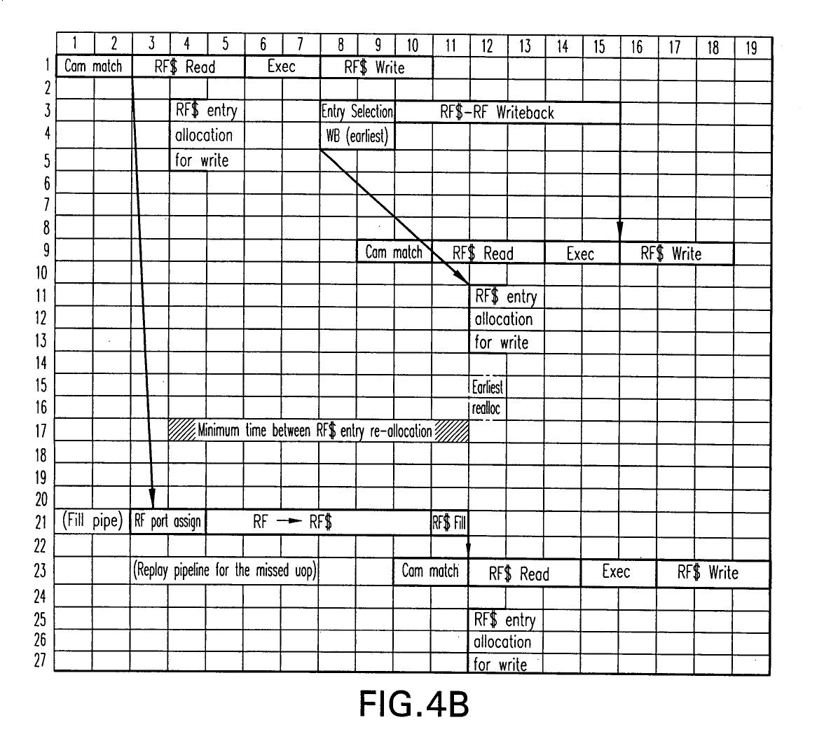

For better understanding of the basic operations of instruction execution and of periodic writeback according to embodiments of the invention, FIG. 4A shows an example which may be viewed as illustrating a progression of two uops through a processor pipeline according to embodiments of the invention. In FIG. 4A, columns numbered 1-26 indicate pipeline stages, where each column corresponds to a discrete clock cycle. The text in rows 1-17 describes operations associated with the various pipeline stages. Thus, FIG. 4A shows that each pipeline stage may be performed in some fixed number of clock cycles. For example, row 1, columns 1 and 2 of FIG. 4A show a “cam match” pipeline stage requiring two clock cycles.

It should be understood that not every operation shown in FIG. 4A necessarily occurs; whether some operations are performed at least partly depends on an outcome of another operation or operations. For example, the operations shown in row 2, columns 5-13 (“RF-->ALU”) depend on the outcome of an earlier operation, specifically, the “cam match” operation in row 1, columns 1-2.

The relative positioning of operations with respect to columns in FIG. 4A should be understood as illustrating the relative timing of operations, if they do occur. For example, the relative positioning of the “RF-->ALU” operation, in terms of column number, with respect to the “cam match” operation, indicates that, if performed, the “RF-->ALU” operation will be performed two clock cycles after the “cam match” operation.

Text in different rows but the same column indicates overlapping operations, if they occur: i.e., that at least parts of respective operations may occur during the same clock cycle or cycles. For example, the “RF$ entry allocation for write” operation (the notation “RF$” stands for the register file cache) shown in rows 3-5, column may be performed during the same cycle as the second half of the “RF port assign” operation shown in row 1, columns 3-4.

As is well known, pipeline stages as represented in FIG. 4A may be implemented by corresponding hardware: i.e., logic gates, wires, power sources, clocks, and so on. Therefore, FIG. 4A represents not only possible sequences of operations, but also the associated physical structures and mechanisms. It should further be understood that FIG. 4A is shown and discussed only by way of illustrative example; embodiments of the invention may be implemented by different pipeline stages and are not limited to those illustrated in FIG. 4A.

Recall now that FIG. 4A may be understood as representing a progression of two uops, say, “uop 1” and “uop 2”, through a pipeline. As will become more clear in the following discussion, rows 1-8 of FIG. 4A show operations involved in execution of uop 1, and operations involved in a periodic writeback of register file cache data to the register file. Rows 9-16 of FIG. 4A show operations involved in execution of uop 2.

Assume uop 1 is scheduled for execution. Row 1 shows the operations of looking in the register file cache for the source operands of uop 1, and if they are found in the register file cache, of reading the operands, executing uop 1, and writing a result to the register file cache. More specifically, columns 1 and 2 of row 1 show a “cam match” operation as described earlier, to determine if the source operands of uop 1 are present in the register file cache. If they are, the operands may be supplied to an ALU (arithmetic/logic unit) of an execution unit as shown in row 1, columns 11-13 (“RF$-->ALU” indicates a transfer of data from the register file cache to an ALU); uop 1 may then be executed as shown in row 1, columns 14-15 (“Exec”), and a result may be written to a register in the register file cache as shown in row 1, columns 16-18 (“RF$ Write”). It should be noted that, as shown in rows 3-5, column 4 (“RF$ entry allocation for write”), an operation to allocate a register in the RF W/B cache for writing the result of uop 1 may have been performed earlier. Considerations involved in the timing of this allocation operation will be discussed in more detail below.

Row 1, columns 3-4 indicate a “RF port assign” operation. This operation may be performed in order to be able to read registers in the register file (RF) in the event the source operands of uop 1 are not present in the register file cache. In row 2, columns 5-13, the notation “RF-->ALU” indicates a transfer of data from the register file to the ALU in the event the source operands are not present in the register file cache and must be retrieved from the register file instead. More specifically, cycles 5-10 of row 2 may be viewed as cycles to access the operands in the register file and move the operands to the boundary of the register file cache, while cycles 11-13 of row 2 may be viewed as cycles wherein the operands are read from the register file cache boundary into the ALU. While the foregoing might appear to be a two-step process (register file to register file cache, register file cache to ALU), in fact, according to embodiments, register contents in the register file may be supplied directly to the ALU. This may be implemented, as noted earlier, by coupling (e.g. via a multiplexer) the busses 204 of the register file to four of the ten read busses between the register file cache and the ALU.

During cycles 11-13, the operands retrieved from the register file may also be written to the RF fill cache, as indicated by the “RF fill” operation in row 3, column 11. As discussed earlier, this operation may be performed so that the operands are readily accessible in case they are soon needed again.

The operations “Entry selection for WB (earliest time)”, “Read selected entries for WB” and “RF$-->RF Writeback” in rows 3-6 relate to a periodic writeback according to embodiments of the invention. More specifically, “Entry selection for WB (earliest time)” in rows 5-6, columns 10-11 indicates a stage for selecting entries (where an “entry” is data in a register) in the RF W/B cache for “eviction”: i.e., for selecting data in those registers in the RF W/B cache that are deemed to not be accessed frequently enough to warrant keeping the data in the RF W/B cache. The selected entries may, accordingly, be written back, e.g. via write busses 202, to the main register file to free up the corresponding registers in the RF W/B cache, so that the results of upcoming instructions can be written to the freed-up registers. According to embodiments of the invention, the entries in the RF W/B cache may be selected for eviction based on a “least recently used” (LRU) policy. LRU algorithms that could be used to select entries for eviction are known in the art.

The operations “Read selected entries for WB” and “RF$-->RF Writeback” in rows 3-4, columns 17-23 represent the actual eviction of the selected entries: i.e., the operations of, respectively, reading those registers in the RF W/B cache whose contents have been selected for eviction, based on the earlier “Entry selection for WB (earliest time)” operation, and writing the contents back to the register file, so that the contents of the registers in the RF W/B cache may now be overwritten by subsequent instructions.

Operations relating to uop 2 are shown in rows 9-16. It may be observed that the operations of uop 2 essentially mirror the operations of uop 1, except that they are shifted or offset by eight cycles with respect to the operations of the uop 1. This offset may reflect a “minimum residency time,” discussed below. It should be noted that the operation wherein uop 2 allocates a register in the RF W/B cache for writing instruction results (“RF$ entry allocation for write” operation, rows 11-13, column 12) may derive the information as to what registers in the RF W/B cache are allocable based on the “Entry selection for WB (earliest time)” operation of cycles 10-11. That is, because the “Entry selection for WB (earliest time)” operation identifies registers that will be written back to the register file, the “RF$ entry allocation for write” operation “knows” that the identified registers will become available for writing instruction results.

According to embodiments, the timing of the periodic writeback operations discussed above may be closely tied to operations to allocate registers in the RF W/B cache for writing results of instructions. The timing of the periodic writeback and allocation operations may involve “minimum residency time” considerations. “Minimum residency time” refers to the amount of time that a register in the RF W/B cache may need to be allocated for writing an instruction result before it can be re-allocated for writing to by another instruction. The size of the RF W/B cache may correlate with the minimum residency time; accordingly, if the minimum residency time can be reduced, the size of the RF W/B cache may be correspondingly reduced. An equivalent way of saying that minimum residency time is reduced is to say that registers are more quickly re-allocable for writing to.

Considerations involved in reducing the minimum residency time include considerations involving how to ensure, if the minimum residency time is reduced, that as a consequence the results of instructions are not prematurely overwritten. One way to ensure that contents of registers in the RF W/B cache are not prematurely overwritten is to write the contents back to the register file (e.g., by a periodic writeback operation as described above) before they may be overwritten in the RF W/B cache. Accordingly, embodiments of the invention may include operations timed to ensure that: (i) all outstanding reads of contents of a register in the RF W/B cache will finish before new data is written into the register; and (ii) the previous contents of the register in the RF W/B cache will have been copied into the register file before the contents are overwritten with the new data.

As noted above, to keep minimum residency time small, registers in the RF W/B cache should be re-allocable quickly. Thus, according to embodiments of the invention, to comply with constraint (i) above while making registers quickly re-allocable, a register in the RF W/B cache may be allocated for writing instruction results at a latest possible point in the pipeline where it can be guaranteed that instructions that may have already “hit” on the register contents (e.g., during a cam match stage) will be able to finish reading the register contents before the instruction allocating the register overwrites the contents. Further, according to embodiments of the invention, entries in the RF W/B cache may be selected for writeback to the register file at an earliest possible time.

It is noted that, for a register in the RF W/B cache to be allocated for writing instruction results, it is not necessary that its contents have already been written back to the register file. Instead, for the register to be allocated, it may only need to be ensured that the register contents have been selected (e.g., based on a LRU policy as described above) for writeback to the register file at some subsequent stage, and that the timing of the allocation will observe constraint (i) above.

It should be understood that when a register is allocated for writing to, the contents of content addressable memory are updated to reflect the allocation of the register to the writing instruction. This has the effect that no instruction having the previous contents of the register as a source will begin to read it after it is allocated to the new writing instruction, because a successful cam match operation for the reading instruction on the previous contents is no longer possible.

On the other hand, unless constraint (i) is observed, it is possible that an instruction could enter the pipeline, perform a successful cam match, and begin to read a source operand, but be unable to complete reading the source operand before a new writing instruction overwrites the source operand. This could lead to an equivocal or indeterminate condition in the pipeline and produce error.

Referring now to the example of FIG. 4A, based on the foregoing considerations the minimum residency time for the particular implementation shown is, conservatively, eight cycles (the meaning of the qualifier “conservatively” is discussed further below), given the timing of the selection of an entries in the R/F W/B cache for writeback to the register file (see “Entry Selection for WB (earliest time)”, rows 5-6, cols. 10-11).

To see this, observe that the latest point in the pipeline where an allocation of a write register in the RF W/B cache may take place without violating constraint (i) is in cycle 4 (see “RF$ entry allocation for write”, rows 3-5, col. 4). Otherwise, register contents may be overwritten before an instruction that has “hit” (performed a successful cam match) on the register contents finishes reading them.

By way of explanation, consider the following example: assume uop 1 allocated, say, physical register 10 in the RF W/B cache for write in, e.g., cycle 5 rather than cycle 4. Further suppose another uop, say, “uop 1.5” having physical register 10 as a source, had entered the pipeline in cycle 3 and performed a successful cam match in stages 3-4 for physical register 10. Referring to row 1 of FIG. 4A, uop 1 would begin to write to register 10 in cycle 16, at the same time as the “Exec” cycle of uop 1.5 was beginning—that is, potentially while uop 1.5 was still reading register 10. On the other hand, if uop 1 allocates register 10 in cycle 4 as shown in FIG. 4A, uop 1.5 cannot successfully perform a cam match for register 10 starting in cycle 3, and consequently does not attempt to read it.

By extension of the above, it follows that uop 2 cannot allocate a write register in the RF W/B cache any later than cycle 12, that a uop following uop 2 cannot allocate a write register any later than cycle 20, and so on. The fact that uop 2 cannot allocate the write register until cycle 12 is also dictated by constraint (ii). That is, uop 2 should only write to the allocated register in the RF W/B cache after the previous contents of the allocated register have been written back to the register file. This means that the write to the allocated register in the RF W/B cache may commence at the earliest at cycle 24. Working back from the write to the RF W/B cache in cycle 24 it can be seen that “RF$ entry allocation for write” should happen in cycle 12 as shown. This together with constraint (i) determines the minimum residency time. The timing of the selection of entries for writeback to the register file ensures that a previously-allocated register is re-allocable for writing to at the earliest possible time: i.e., eight cycles following the last allocation of a register for writing, since eight cycles is the minimum time required to guarantee that at least one previously-allocated register is available for re-allocation. Thus, recalling that minimum residency time is the time a register must remain allocated before it can be re-allocated to a new instruction, the minimum residency time 400 for the particular implementation of FIG. 4A is, conservatively, eight cycles. The qualifier “conservatively” is applied here to take recognition of the fact that various actual hardware implementations may exhibit varying read and write times, and timing of pipeline stages could be adjusted to reflect observation of actual hardware performance.

In implementation of FIG. 4A, the pipeline stages required for retrieving data from the register file in case of the register file cache miss (e.g., stages 5 to 10 in FIG. 4A) are “inline” with a main pipeline through which all uops flow. FIG. 4B shows an example of a pipeline where the pipeline stages required for retrieving the data from the register file in the event of a miss can be “offline” with the main pipeline. This removes the pipelines stages required to retrieve data from the register file and to place them in the register file cache (e.g, stages 5 to 10 in FIG. 4A) from the main, more frequently used pipeline, allowing the uops that hit (find their data) in the register file cache, which is the more frequent case than missing, to not be delayed by passing through the stages required to handle a miss. FIG. 4B may be read in substantially the same way as FIG. 4A. A difference between the pipeline of FIG. 4A and the pipeline of FIG. 4B is that if an instruction's source operands are not found in the register file cache, the operands may be read from the register file into the RF W/B cache and RF fill cache and the instruction may be replayed. This process is illustrated in FIG. 4B by the arrow connecting the “cam match” operation of row 1, columns 1-2 and the sequence of operations beginning with “RF port assign” in row 20, column 3. The sequence of operations (“RF port assign”, RF-->RF$” and “RF$ Fill”) represent operations to read the needed operands from the register file into the RF W/B cache and RF fill cache. The instruction may then be replayed as indicated by the operations starting in column 10 of row 23.

Register File Cache Structure

As noted earlier, as data storage structures become more heavily ported, they must typically become larger, consequently incurring a greater penalty in terms of area requirements, access latency and power consumption. By way of illustration, suppose a memory cell needed to be accessed only by a single execution unit. The memory cell would need to have an area able to accommodate the corresponding porting: i.e., able to accommodate access from a bitline and wordline. Now suppose the same memory cell needed to be accessed by two execution units. The memory cell would now need to have an area able to accommodate another bitline and another wordline. Thus, as can be seen by the foregoing example, as porting increases due to a need for shared access to memory, the associated area requirements grow, not linearly, but by approximately a power of two. Accordingly, embodiments of the present invention relate to reducing the area required for data storage structures described above, by, among other things, providing for exclusive rather than shared access to the data storage structures.

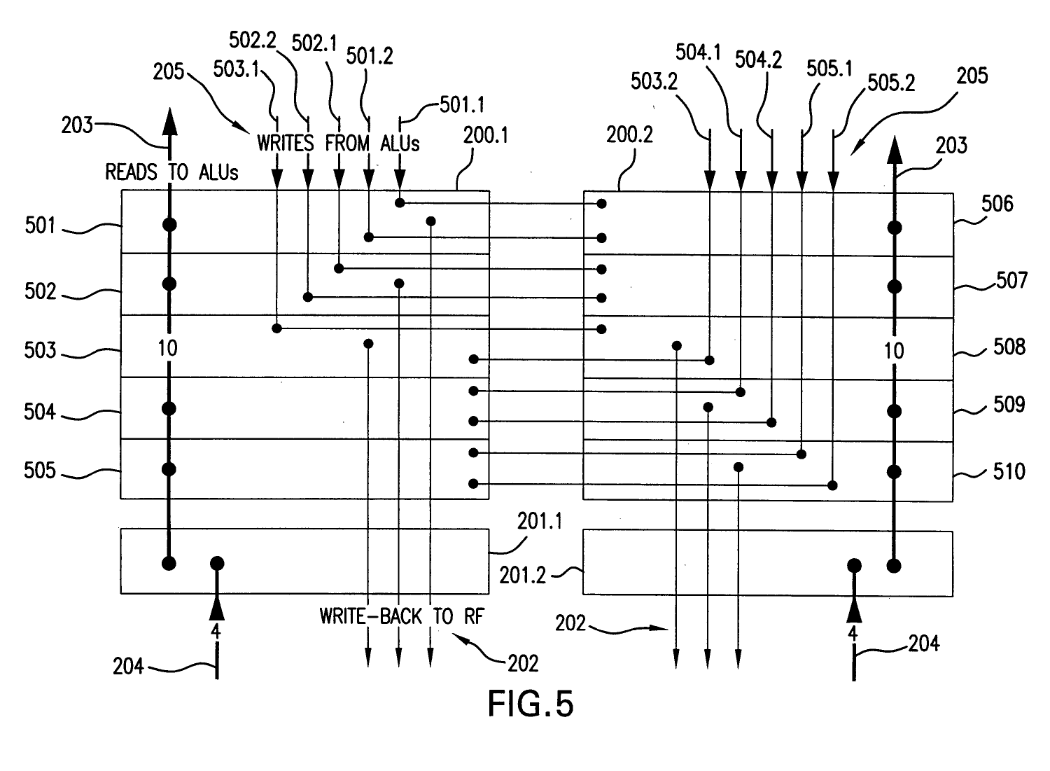

FIG. 5 illustrates more details of a register file cache structure according to embodiments of the present invention than shown in previous figures, and in particular, illustrates exclusive access to portions of the register file cache structure. The structure of FIG. 5 may provide for further reduction in register file cache size. It should be understood that FIG. 5 is shown and discussed only by way of illustrative example; embodiments of the invention may be implemented in various different forms and are not limited to those illustrated in FIG. 5.

As shown, each section 200.1, 200.2 of the RF W/B cache 200 of a register file cache 103 according to embodiments may comprise a plurality of “banks” or subsections 501-510. An exclusive set of write busses may be provided for a pair of subsections, where each subsection of the pair is in a different section 200.1, 200.2. For example, write busses 501.1 and 501.2 are coupled to subsection 501 in section 200.1 and to subsection 506 in section 200.2, respectively, but not to any other subsection; write busses 502.1 and 502.2 are coupled to subsections 502 and 507, but not to any other subsection; write busses 503.1 and 503.2 are coupled to section 503 and 508, but not to any other section; write busses 504.1 and 504.2 are coupled to subsections 504 and 509, but not to any other subsection; and write busses 505.1 and 505.2 are coupled to subsections 505 and 510, but not to any other section. According to embodiments, each exclusive set of write busses may only be able to write to the associated pair of subsections.

Using the arrangement described above, data written in section 200.1 may be replicated in section 200.2, and vice versa. That is, a write using busses 501.1 and 501.2 writes the same data to both subsection 501 and subsection 506; a write using busses 502.1 and 502.2 writes the same data to both subsection 502 and subsection 506; and so on. In this way, sections 200.1 and 200.2 may be kept consistent with each other. Because each subsection 501-510 has only two busses that can write to it, each memory cell thereof need only have two ports, and can therefore be formed with a smaller area than a greater number of ports would require. Although the arrangement involves replication of data and consequently replication of area needed for corresponding data storage structures, in the aggregate the arrangement may require less area than an arrangement which attempts to provide shared access to each memory cell as opposed to exclusive access in the sense described above.

Ten read busses 203 may be provided for each section 200.1/201.1, 200.2/201.2. Because data is replicated across sections 200.1 and 200.2, reads can be performed from either section. Thus, the ten read busses can support ten-uop-wide execution (i.e., five execution units provided with operands by section 200.1/201.1 and five execution units provided with operands by section 200.2/201.2), where each uop has two sources, where otherwise twenty read busses might typically be required. Again, the number of busses illustrated in FIG. 5 is chosen merely for purposes of illustration. The number could vary among different implementations.

Embodiments of the invention may further provide for “track-sharing” as further illustrated in FIG. 5. More specifically, busses 202 to perform a periodic write-back of data from the RF W/B cache to the register file, as described earlier, may be arranged to share “tracks” with write busses 205. “Track” refers to a conductor in the silicon layout represented in FIG. 5. As can be seen in FIG. 5, two of the write-back busses 202 lie along the same lines as busses 501.1 and 501.2, respectively, and two of the write-back busses 202 lie along the same lines as busses 503.2 and 504.1, respectively, indicating that the write-back busses 205 and the corresponding busses 501.1, 501.2, 503.2, 504.1 share a common conductor. This arrangement may contribute to helping the register file cache to be formed to be comparatively narrow. It may be further observed that a first set of write-back busses 202 are respectively coupled exclusively to subsections 501, 502 and 503, while a second set of write-back busses 202 are respectively coupled exclusively to subsections 508, 509 and 510. This arrangement may reduce the number of busses that need to be routed on the register file cache.

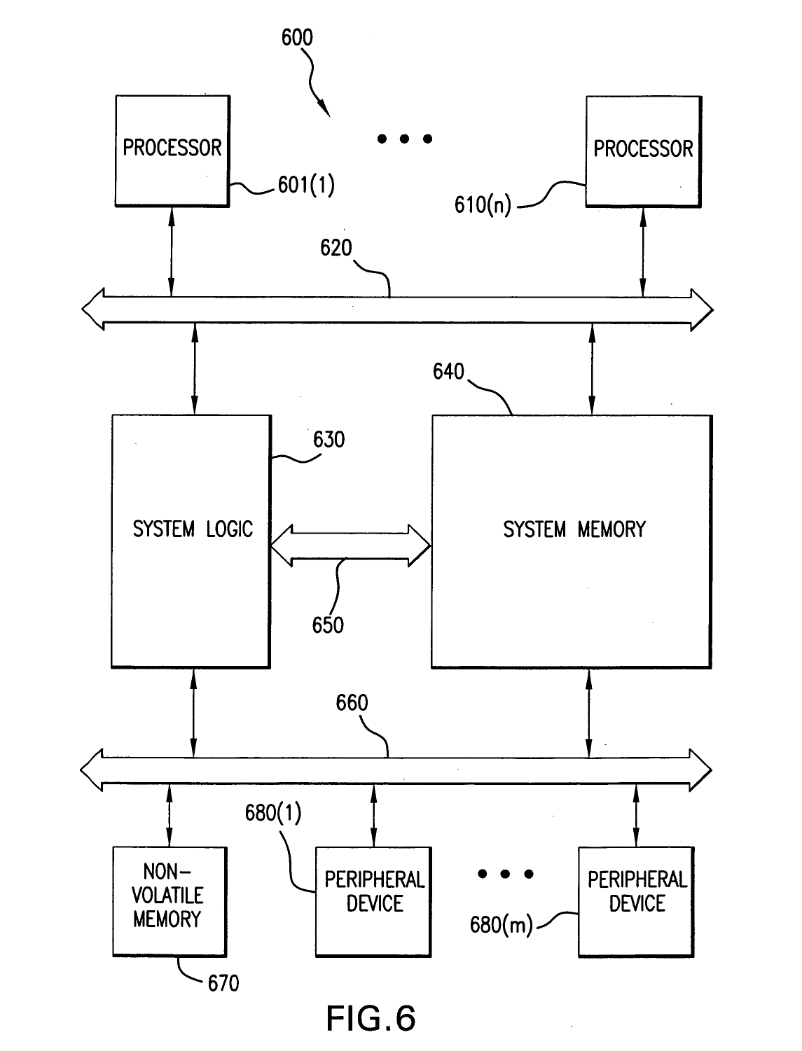

FIG. 6 is a block diagram of a computer system, which may include an architectural state, including one or more processors and memory for use in accordance with an embodiment of the present invention. In FIG. 6, a computer system 600 may include one or more processors 610(1)-610(n) coupled to a processor bus 620, which may be coupled to a system logic 630. Each of the one or more processors 610(1)-610(n) may be N-bit processors and may include a decoder (not shown) and one or more N-bit registers (not shown). System logic 630 may be coupled to a system memory 640 through a bus 650 and coupled to a non-volatile memory 670 and one or more peripheral devices 680(1)-680(m) through a peripheral bus 660. Peripheral bus 660 may represent, for example, one or more Peripheral Component Interconnect (PCI) buses, PCI Special Interest Group (SIG) PCI Local Bus Specification, Revision 2.2., published Dec. 18, 1998; industry standard architecture (ISA) buses; Extended ISA (EISA) buses, BCPR Services Inc. EISA Specification, Version 3.12, 1992, published 1992; universal serial bus (USB), USB Specification, Version 1.1, published Sep. 23, 1998; and comparable peripheral buses. Non-volatile memory 670 may be a static memory device such as a read only memory (ROM) or a flash memory. Peripheral devices 680(1)-680(m) may include, for example, a keyboard; a mouse or other pointing devices; mass storage devices such as hard disk drives, compact disc (CD) drives, optical disks, and digital video disc (DVD) drives; displays and the like.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A processor comprising:
a register file;
an execution unit; and
a register file cache coupled to the register file and to the execution unit.

2. The processor of claim 1, wherein the register file cache comprises a write-back portion to receive a result of an instruction executed by the execution unit.

3. The processor of claim 1, wherein the register file cache comprises a fill portion to receive an operand read from the register file.

4. An apparatus comprising:
a first data storage structure to hold instruction operands;
a second data storage structure to hold instruction operands, coupled to the first data storage structure; and
a logic device coupled to the first data storage structure and to the second data storage structure, to execute instructions using operands read from either the first data structure or from the second data structure.

5. The apparatus of claim 4, further comprising:
a data-management mechanism to move data corresponding to an operand from the second data storage structure to the logic device when the data is not present in the first data storage structure.

6. The apparatus of claim 5, further comprising:
a write-back mechanism to move data from the first data storage structure to the second data storage structure.

7. The apparatus of claim 6, wherein the write-back mechanism moves the data based on a frequency of access to the data.

8. The apparatus of claim 4, wherein the first data storage structure includes a write-back portion to which to write results of instructions executed by the logic device.

9. The apparatus of claim 5, wherein the first data storage structure includes a fill portion, and the data-management mechanism is to copy the data from the second data storage structure to the fill portion.

10. The apparatus of claim 4, wherein the first data storage structure is more ported than is the second data storage structure.

11. The apparatus of claim 4, further comprising an allocation mechanism to allocate a register in the first data structure to which to write an instruction result, wherein the allocate mechanism is to allocate the register such that the result will be written to the register only when all outstanding reads of contents of the register have completed.

12. The apparatus of claim 11, further comprising a write-back mechanism to move data from the first data storage structure to the second data storage structure, wherein the write-back mechanism is to cooperate with the allocation mechanism such that previous contents of the register will have been moved to the second data structure before the contents are overwritten by the result.

13. The apparatus of claim 4, wherein the first data storage structure comprises a first section and a second section, each of the first and second sections being divided into a plurality of subsections, wherein a subsection of the first section and a subsection of the second section have an exclusive set of write paths thereto.

14. The apparatus of claim 4, wherein the first data storage structure includes shared tracks.

15. A method comprising:
arranging a register file cache to communicate with an execution unit and a register file;
searching the register file cache for an instruction operand of an instruction to be executed by the execution unit; and
if the operand is found in the register file cache, reading the operand from the register file cache.

16. The method of claim 15, further comprising:
if the operand is not found in the register file cache, reading the operand from the register file.

17. The method of claim 16, further comprising:
copying the operand that is read from the register file to the register file cache.

18. The method of claim 16, further comprising:
executing the instruction; and
writing a result of the instruction to the register file cache.

19. The method of claim 15, further comprising:
periodically writing data from the register file cache to the register file.

20. The method of claim 19, wherein the data are written based on a least-recently-used policy.

21. The method of claim 18, further comprising:
allocating a register in the register file cache to which to write the instruction result, such that the result will be written to the register only when all outstanding reads of contents of the register have completed.

22. The method of claim 18, further comprising
allocating a register in the register file cache to which to write the instruction result;
periodically writing data from the register file cache to the register file; and
timing the allocating and the periodic writing such that previous contents of the register will have been moved to the register file before the contents are overwritten by the result.

23. A system comprising:
a memory to hold instructions for execution;
a processor coupled to the memory to execute the instructions, the processor including:
a register file;
an execution unit; and
a register file cache coupled to the register file and to the execution unit.

24. The system of claim 23, wherein the register file cache comprises a write-back portion to receive a result of an instruction executed by the execution unit.

25. The system of claim 23, wherein the register file cache comprises a fill portion to receive an operand read from the register file.
